(19) United States
(12) Patent Application Publication
(10) Pub. No.: US 2015/0195593 A1
(43) Pub. Date: Jul. 9, 2015

(54) CONTENT DIRECTION BASED ON CUMULATIVE USER COST

(71) Applicant: GOOGLE INC., Mountain View, CA (US)

(72) Inventor: Neil Hoyne, Mountain View, CA (US)

(73) Assignee: GOOGLE INC., Mountain View, CA (US)

(21) Appl. No.: 14/051,238

(22) Filed: Oct. 10, 2013

(51) Int. Cl. H04N 21/258; H04N 21/45; H04N 21/658

(52) U.S. Cl. CPC H04N 21/25866; H04N 21/6582; H04N 21/4508

(57) ABSTRACT

Systems, methods, and computer-readable storage media that may be used to limit exposure of content to users based on a cumulative user cost are provided. One method includes calculating a cumulative user cost based on previous interactions of a user with one or more content items of a content campaign. The method further includes determining an expected revenue contribution resulting from a conversion. The method further includes determining whether to cause a content management system serving content items to limit serving of content items of the content campaign to the user based on the comparison of the cumulative user cost to the expected revenue contribution.

### BACKGROUND

Content providers often publish content items in networked resources through online content management systems with the goal of having an end user interact with (e.g., click through) the content items and purchase a product or service offered by the content providers. The content providers are typically charged a fee each time an impression of the content item is displayed to a user and/or each time a user selects or otherwise clicks through an impression of the content item. Many content providers look only at a single user interaction to determine whether a displayed content item is successful (e.g., whether the user converted, purchasing an associated product/service, or did not convert). Evaluating the interaction of a user with a content item in this manner only tells the content provider whether or not the single interaction resulted in a conversion, and provides no indication as to whether the cumulative interaction of the user with a content campaign over a series of impressions was profitable to the content provider.

### SUMMARY

One illustrative implementation of the disclosure relates to a method that includes receiving, at a computerized analysis system, path data indicating one or more previous interactions of a user with one or more content items of a content campaign. The method further includes receiving, at the analysis system, cost data used to determine a cost, to a content provider associated with the content campaign, of the one or more previous interactions. The method further includes calculating, using the analysis system, a cumulative user cost based on the path data and the cost data. The method further includes determining an expected revenue contribution from the user resulting from a conversion. The method further includes comparing, using the analysis system, the cumulative user cost to the expected revenue contribution from the user. The method further includes determining, using the analysis system, whether cause a content management system serving content items to limit serving of content items of the content campaign to the user based on the comparison of the cumulative user cost to the expected revenue contribution.

Another implementation relates to a system including at least one computing device operably coupled to at least one memory. The at least one computing device is configured to receive path data indicating one or more previous interactions of a user with one or more content items of a content campaign and to receive cost data used to determine a cost, to a content provider associated with the content campaign, of the one or more previous interactions. The at least one computing device is further configured to calculate a cumulative user cost based on the path data and the cost data. The at least one computing device is further configured to determine an expected revenue contribution from the user resulting from a conversion. The at least one computing device is further configured to compare the cumulative user cost to the expected revenue contribution from the user and to determine whether to cause a content management system serving content items to limit serving of content items of the content campaign to the user based on the comparison of the cumulative user cost to the expected revenue contribution.

Yet another implementation relates to one or more computer-readable storage media having instructions stored thereon that, when executed by at least one processor, cause the at least one processor to perform operations. The operations include receiving path data indicating one or more previous interactions of a user with one or more content items of a content campaign, receiving cost data used to determine a cost, to a content provider associated with the content campaign, of the one or more previous interactions, and calculating a cumulative user cost based on the path data and the cost data. The operations further include determining an expected revenue contribution from the user if a content item of the content campaign is displayed to the user and the user selects the content item and subsequently purchases a product or service associated with the content item. The operations further include comparing the cumulative user cost to the expected revenue contribution from the user and placing an identifier associated with the user in a negative remarketing list when the cumulative user cost exceeds the expected revenue contribution from the user. The negative remarketing list is associated with at least one of the content provider and the content campaign, and the negative remarketing list is configured to cause a content management system serving content items to users to not serve content items of the content campaign to users when identifiers associated with the users appear in the negative remarketing list.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for limiting exposure of one or more content items of a content campaign to a user based on a cumulative user cost associated with the user according to an illustrative implementation.

FIG. 3 is a flow diagram of a process for determining whether to cause a content management system to limit serving of content items of a content campaign to a user according to an illustrative implementation.

FIG. 4 is a flow diagram of a process for determining whether to cause a content management system to limit serving of content items of a content campaign to a user based in part on an estimated likelihood of conversion according to an illustrative implementation.

FIG. 5 is a block diagram of a computing system according to an illustrative implementation.

### DETAILED DESCRIPTION

Referring generally to the Figures, various illustrative systems and methods are provided that may be used to limit exposure of content to users based on a cumulative user cost. Many content providers look only at a single user activity to determine whether a displayed content item is successful (e.g., whether the user converted or did not convert), without considering whether the overall long-term interaction with the user was profitable. A company expected to earn a profit of $X for a campaign or keyword should have no motivation to pay any more than $X for each conversion. Consider, for example, a set of ten users, where nine of them click on one content item each at a $5 cost per click (CPC), earning the content provider $10 each, or $90 revenue for a $45 cost overall. Assume that a tenth customer clicks on the same content item 20 times and converts for the same amount as the previous nine. The individual cost of the tenth customer is $100, with a marginal contribution of only $10, leading to a loss of $90. Further, when the content provider looks at reporting for the keyword in aggregate, $100 in revenue was generated for $145 in costs, making it unprofitable to continue investing in that term at the set rate. In response, the content provider is likely to pull back on spend and incremental sales due to the actions of a very small portion of the user population. In some implementations, frequency capping may be used to avoid a user being presented with impressions overly frequently, but this method of limiting exposure is not related to a cumulative cost associated with the user. Additionally, some methods may capture user behavior indicators and exclude users based on certain high-level behavior or characteristic parameters. Such methods are heavy-handed, and may exclude profitable users in the segment being removed.

The present disclosure provides illustrative systems and methods that may be used to identify such unprofitable users and discontinue providing content items to them. An analysis system may collect one or more data items relating to a particular user and analyze the cumulative cost of the user in comparison to the user's expected revenue contribution. The analysis system may determine the cumulative cost of the user based on user path data indicating one or more prior interactions of the user with a content item and/or a content campaign to which the content item belongs. The analysis system may estimate the cost of the previous interactions using cost data associated with the item(s) with which the user previously interacted (e.g., cost associated with keywords, etc.). From this data, the analysis system may calculate an estimated cumulative cost of the user. The analysis system may also determine an expected revenue contribution for the user. In various implementations, the expected revenue contribution may be determined based on previous conversions (e.g., average revenue contribution for one or more users who clicked through a content item associated with the campaign and purchased a product/service), revenue/profit data provided by the content provider, and/or other data.

The analysis system may determine whether the cumulative costs associated with the user exceed the expected revenue contribution of the user. If so, the analysis system may be configured to cause a content management system serving content items to users to limit serving of content items from the content campaign to the user (e.g., limit or reduce a number of impressions of the content items served to the user or stop content items from the content campaign from being served to the user). In some implementations, an identifier associated with the user and/or the user's device may be placed on a negative remarketing list. The negative remarketing list may cause a content management system not to serve items from the content campaign to the user, or limit the number of exposures of the content campaign to the user, for a particular duration of time. This may help prevent one particular user, or a small group of users, from disproportionately affecting the outcome of a content campaign.

In some implementations, exceptions may be made to provide content campaign items to a user even if cumulative cost of the user exceeds an expected revenue contribution for the user. For example, a content provider may wish to continue presenting content items to a potential new customer, even if the cumulative costs associated with the user would make doing so unprofitable. The content provider may wish to continue presenting content items past the point of profitability if the profit margin associated with the product being marketed by the content item is high (e.g., car, jewelry, etc.). In some implementations, the content provider may have a business interest in continuing to present content items past the profitability point, such as to saturate a particular market segment.

In some implementations, the analysis system may be configured to estimate the user's likelihood of conversion through incremental marketing actions. For example, the analysis system may review a set of user path data relating to interactions of the user with previously displayed content items. In some implementations, the analysis system may utilize interaction data for content items and/or users sharing one or more similar characteristics with the content item/campaign and/or users being analyzed (e.g., product price, content items/product type, etc.) to perform the analysis, including converting and/or non-converting path data. Based on the user path analysis, the analysis system may be configured to estimate the likelihood that the user will convert the displayed content item into a sale within one more impression, two more impressions, etc. Based on this estimation, the analysis system may determine whether a content item should be displayed to the user despite the cumulative costs of the user exceeding the expected revenue contribution. The analysis system may be configured to allow a content item to be displayed if there is a high likelihood of near-term conversion, such that the near-converting user may be less unprofitable if one or more additional content items are displayed than if the user were abandoned altogether. For example, if an incremental $5 click is highly likely to drive a $10 conversion, that content item may be displayed, even though the user will still be unprofitable overall.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

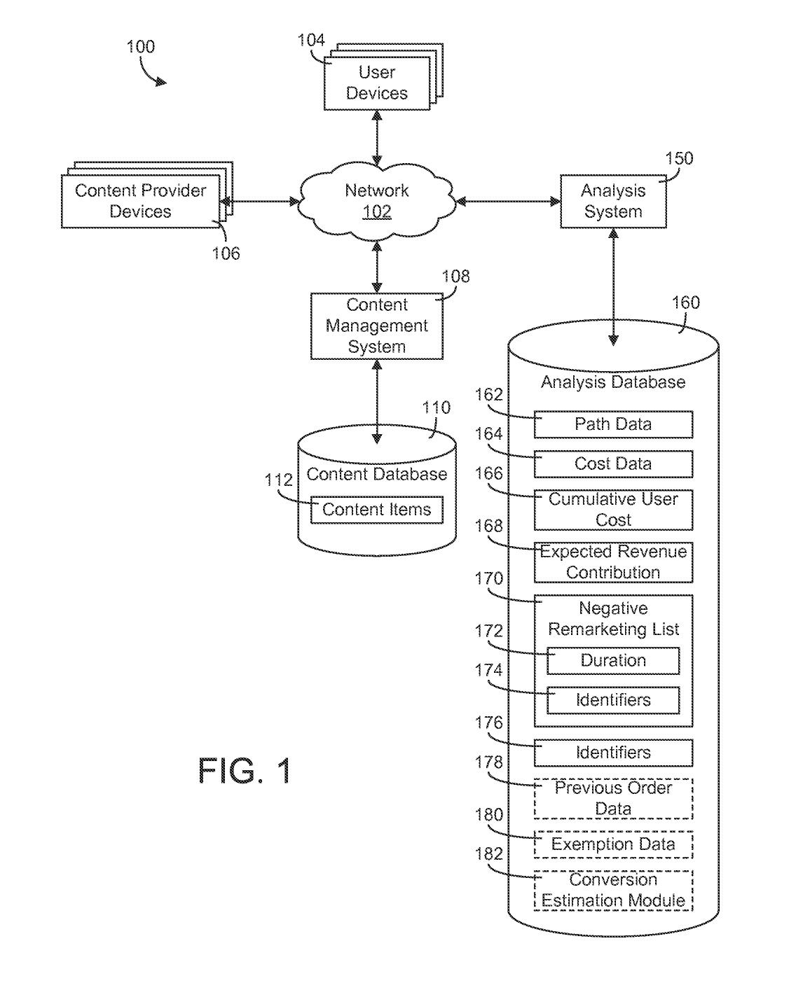

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

In some implementations, an analysis system 150 may be configured to analyze data relating to one or more users of user devices 104 and determine whether content items of a content campaign should be presented to the user device 104 of a user based on a cumulative user cost 166 for the campaign or content item. For example, analysis system 150 may utilize data relating to previous interactions of the user with the content item and/or other content items from the content campaign, as well as costs associated with those previous interactions, and determine a cumulative user cost 166 of the previous interactions. Analysis system 150 may compare this cost to an expected revenue contribution 168 resulting from a conversion (e.g., if the user purchases a product or service associated with the content item) and, based on the comparison, may determine whether further impressions of the content item and/or other content items of the content campaign should be presented to the user device 104 of the user. In this manner, analysis system 150 may evaluate whether further interaction of the user with the content campaign would be likely to be profitable to the content provider, or whether the content provider should no longer invest in presenting content items from the content campaign to the user. This may help prevent one, or a small number, of unprofitable users from skewing the results of a content campaign and wasting the investment of the content provider.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other example parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

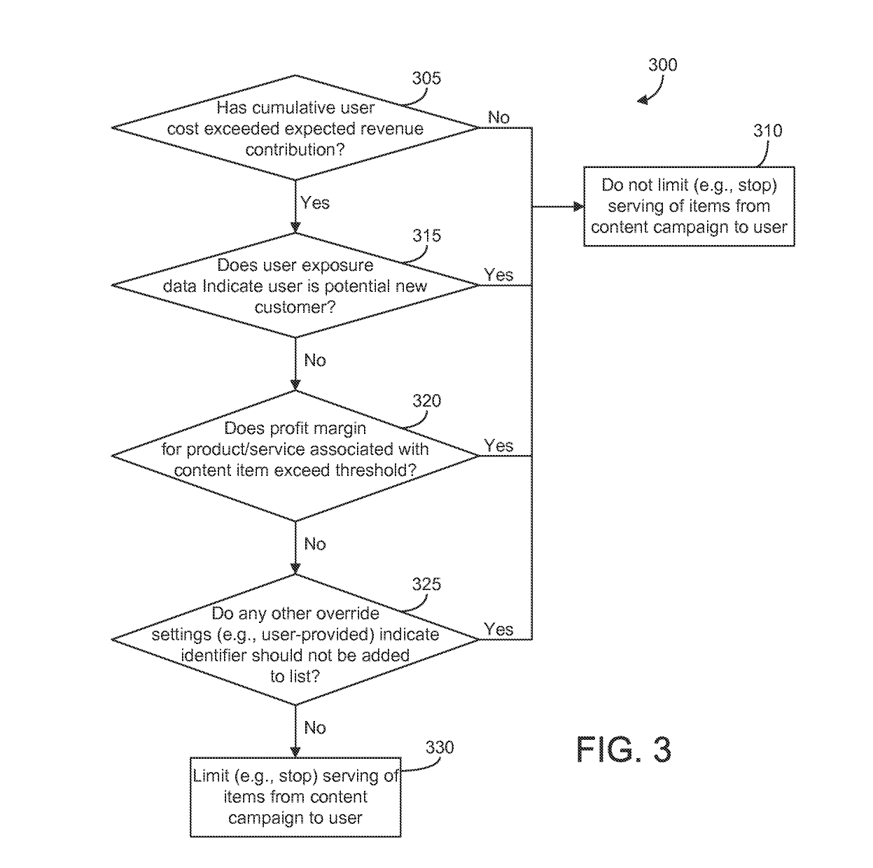

Analysis system 150 may interact with user devices 104, content provider devices 106, content management system 108, and/or various other devices and/or systems to collect data for use in performing analysis of user costs and revenue contributions and/or to generate and/or update one or more negative remarketing lists. Analysis system 150 may store and/or retrieve data for use in performing various analyses in an analysis database 160. As described in further detail with respect to FIGS. 3-5, according to illustrative implementations, analysis system 150 may utilize path data 162 and cost data 164 relating to previous interactions of a user with content items of a content campaign to determine cumulative user cost 166 for the user. Analysis system 150 may compare cumulative user cost 166 with expected revenue contribution 168 of the user to determine whether or not to cause content management system 108 to limit serving items from the content campaign to the user (e.g., limit or reduce a number of impressions of the content items served to the user or stop content items from the content campaign from being served to the user). For example, analysis system 150 may determine whether an identifier (e.g., a browser cookie) associated with the user should be placed on a negative remarketing list 170 associated with the content campaign and/or content provider. Content management system 108 may utilize negative remarketing list 170 to determine one or more users devices 104 to which content from particular campaigns should not be presented. For example, if an identifier associated with a user of a user device 104 is on a negative remarketing list associated with a particular content campaign, and content management system 108 receives a request to serve content to that user device 104, content management system 108 may exclude the content campaign from consideration when determining content items to serve to the user device 104. In some implementations, analysis system 150 may cause content management system 108 to limit or stop serving of items to the user without using methods other than those involving negative remarketing lists. For example, in some implementations, analysis system 150 may transmit a command to content management system 108 identifying a particular identifier of a user to whom content items from a content campaign should not be presented, rather than including the identifier on a list. In some implementations, analysis system 150 and content management system 108 may be integrated within a single system (e.g., content management system 108 may be configured to incorporate some or all of the functions/capabilities of analysis system 150).

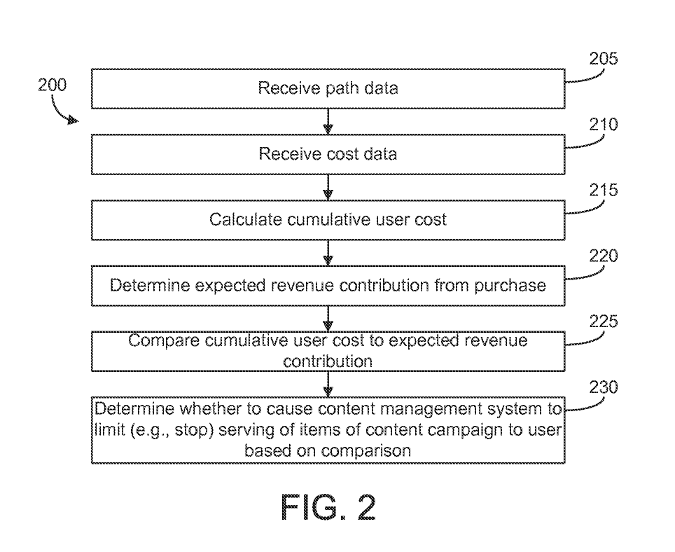

FIG. 2 illustrates a flow diagram of a process 200 for limiting exposure of one or more content items of a content campaign to a user based on a cumulative user cost associated with the user according to an illustrative implementation. Referring to both FIGS. 1 and 2, analysis system 150 may be configured to receive path data 162 indicating one or more previous interactions of a user with one or more content items of a content campaign (205). The content campaign may include one or more content items that the content provider wishes to have presented to user devices 104 by content management system 108. In some implementations, each of the content items may have one or more products and/or services associated with the content item. In some implementations, each content item may be designed to promote one or more particular products and/or services. In some implementations, some content items may be configured to promote the content provider, an affiliate of the content provider, a resource (e.g., website) of the content provider, etc. in general, and the products and/or services associated with the content item may be any products and/or services offered for sale through the content provider, affiliate, resource, etc.

Path data 162 may include any type of data from which information about previous interactions of a user with a content campaign can be determined. The interactions may be instances where impressions of a campaign content item have been displayed on the user device of the user, instances where the user clicked through or otherwise selected the content item, instances where the user converted (e.g., purchased a product/service as a direct or indirect result of an interaction with a campaign content item), etc. In some implementations, path data 162 may include resource visitation data collected by analysis system 150 describing some or all activities leading to a website or other resource of the content provider. Analysis system 150 may collect information relating to a portion of the resource visited/accessed, an identifier 176 associated with the user or user device that accessed the resource, information relating to an origin or previous location that the user/device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed. Analysis system 150 may utilize the visitation data to identify instances of the user/device previously interacting with one or more content items of the content campaign. In some implementations, path data 162 may include result data associated with a resource visit or other user interaction with one or more content items of the content campaign. The result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions resulting from visits/interactions.

In various implementations, identifier 176 may be a browser cookie, a unique device identifier (e.g., a serial number), a device fingerprint (e.g., collection of non-private characteristics of the user device), or another type of identifier. Identifier 176 does not include personally identifiable data from which an actual identity of the user can be discerned. Analysis system 150 may be configured to require consent from the user to tie identifier 176 to path data 162. In some implementations, path data from multiple sources may be utilized even if the path data sets reference different types of identifiers. For example, user paths may be joined by matching one identifier (e.g., browser cookie) with another identifier (e.g., a device identifier) to associate both path data sets as corresponding to a single user.

Analysis system 150 may also receive cost data 164 used to determine a cost, to the content provider associated with the content campaign, of the previous interactions of the user with the content items (210). Cost data 164 may be received from content management system 108, received from another type of system, or generated by analysis system 150. In some implementations, cost data 164 may identify a cost associated with each of the specific interactions identified in path data 162. For example, each of the interactions may be identified by an interaction identifier, and cost data 164 may identify a cost to the content provider associated with the interaction identifier. In some implementations, cost data 164 may identify costs associated with particular characteristics of the interactions reflected in path data 162 generally, and analysis system 150 may be configured to generate cost data for each specific interaction based on the general cost data. For example, cost data 164 may identify costs associated with particular keywords associated with the campaign, path data 162 may identify keywords associated with each of the interactions, and analysis system 150 may determine a cost for each interaction by correlating the keyword cost data with the keywords reflected in path data 162.

Using both path data 162 and cost data 164, analysis system 150 can calculate a cumulative user cost 166 for the previous interactions of the user/device with the content campaign (215). Cumulative user cost 166 may represent a cost paid by the content provider thus far in interactions with the user through the content campaign. In some implementations, if previous interactions have resulted in conversions (e.g., purchases), the revenue (e.g., profit) associated with those conversions may be accounted for by analysis system 150. For example, system 150 may be configured to reduce cumulative user cost 166 by an amount based on (e.g., equal to) the amount of revenue the previous interactions of the user with the campaign have generated.

Analysis system 150 may be configured to determine an expected revenue contribution 168 from the user resulting from a conversion (e.g., if a content item impression from the content campaign is displayed to the user and the user selects the content item and subsequently purchases a product or service) (220). In some implementations, a conversion may occur when the user is presented with an impression of a campaign item, and the user subsequently purchases a product/service as a result of the interaction. In other implementations, a conversion may refer to receiving information from the user as a result of the interaction, such as information that may be used by the content provider to interact more successfully with the user (e.g., identify content items, offers, etc. to present to the user in the future that may be of interest to the user based on the information). A conversion generally may refer to any activity of the user occurring subsequent to interaction of the user with a content item of the content campaign that provides some benefit to the content provider and/or is relevant to the progression of a relationship between the user and the content provider.

In some implementations (e.g., when the content item is linked to a specific product or service), analysis system 150 may be configured to receive profit margin data associated with the product or service (e.g., from the content provider). In some implementations, system 150 may receive cost data and sales price data associated with the product or service, and may be configured to calculate a profit margin. In some implementations (e.g., when the content item is linked to a general resource, such as a general website or a portion of a website on which many different products/services are promoted), system 150 may be configured to receive and/or generate an average order value for the relevant resource or portion of the resource (e.g., based on previous order data 178 from previous orders, such as a total price of previous orders, an itemized price of previous orders, an identification of ordered items, etc.) and use that figure as an estimate for expected revenue contribution 168.

Analysis system 150 may be configured to compare cumulative user cost 166 to expected revenue contribution 168 (225) and determine whether to cause content management system 108 to limit serving of items from the content campaign to the user based on the comparison (e.g., limit or reduce a number of impressions of the content items served to the user or stop content items from the content campaign from being served to the user) (230). In some implementations, analysis system 150 may indicate that serving of items to a user should be limited or discontinued by placing an identifier associated with the user on a negative remarketing list 170. Negative remarketing list 170 may include one or more identifiers 174 associated with users to whom content items for one or more campaigns should not be served (e.g., by content management system 108). In some implementations, negative remarketing list 170 may be linked to one or more particular content campaigns and may not affect other campaigns of a content provider. In some implementations, negative remarketing list 170 may be linked with the content provider and may be used to limit exposure of content items in all campaigns of the content provider. In some implementations, negative remarketing list 170 and/or one or more identifiers 174 on the list may have a duration 172 during which identifiers stay on the list (e.g., after which content items from a content campaign may once again be presented to the associated user devices). In some implementations, duration 172 may be specified and/or alterable by the content provider.

In some implementations, analysis system 150 may be configured to place an identifier on negative remarketing list 170 when cumulative user cost 166 is greater than expected revenue contribution 168, such that the user is estimated to be unprofitable even if the next impression results in a conversion. In some implementations, analysis system 150 may be configured to place an identifier on negative remarketing list 170 when cumulative user cost 166 is within a threshold amount of expected revenue contribution 168 (e.g., before the user is estimated to be unprofitable). In some implementations, analysis system 150 may be configured to place an identifier on negative remarketing list 170 when cumulative user cost 166 is greater than expected revenue contribution 168 by a threshold amount (e.g., such that some impressions are shown after the user has been estimated to be unprofitable, but the amount of impressions are limited). In some implementations, analysis system 150 may be configured to exempt an identifier from placement on negative remarketing list 170 based on one or more exemptions specified in exemption data 180, such as those described in further detail with respect to FIG. 3 according to one illustrative implementation.

Content management system 108 may be configured to receive negative remarketing list 150 and use negative remarketing list 150 to determine whether to serve content items of one or more content campaigns to particular user devices 104 (e.g., whether to include the content campaigns in an auction for content items to be served to a particular user device). In some implementations, content management system 108 may be configured to limit a number of impressions of a particular content item/campaign presented to a user based on the inclusion of an identifier associated with the user on negative remarketing list 170. In some implementations, content management system 108 may be configured to completely block items from a content campaign from being served to a user associated with an identifier on negative remarketing list 170. In various implementations, analysis system 150 may be configured to transmit negative remarketing list 150 to content management system 108, or content management system 108 may have access to a memory storing negative remarketing list 170 and/or identifiers 176 (e.g., a shared memory space between content management system 108 and analysis system 150).

FIG. 3 shows a flow diagram of a process 300 for determining whether to cause content management system 108 to limit serving of items of a content campaign to a user (e.g., determining whether to place an identifier associated with a user on a negative remarketing list) according to an illustrative implementation. In some implementations, process 300 includes an illustrative operation providing a test for determining whether an identifier should be placed on negative remarketing list 170, as well as several illustrative operations for determining whether to exempt the identifier from placement on negative remarketing list 170 (e.g., based on exemption data 180).

Referring now to both FIGS. 1 and 3, analysis system 150 may determine whether cumulative user cost 166 has exceeded expected revenue contribution 168 (305). If not, analysis system 150 does not cause content management system 108 to limit serving of campaign items to the user (e.g., does not place the identifier on negative remarketing list 170) (310).

If cumulative user cost 166 has exceeded expected revenue contribution 168, analysis system 150 may determine whether one or more exemptions apply that should exempt the identifier from placement on negative remarketing list 170. In some implementations, analysis system 150 may determine whether the user is a potential new customer of the content provider (315). The content provider may be willing to accept a short-term loss on the interactions of the user with the analyzed content campaign, because the customer lifetime value of the potential new customer (e.g., the value of the customer over the span of a long-term seller-customer relationship) may outweigh the short-term loss for the content provider. Analysis system 150 may determine whether the user is a potential new customer based on user exposure data relating to the user's previous interaction, or lack thereof, with the content provider and/or resources of the content provider. In some implementations, the user exposure data may include visitation data describing the user's previous interactions with resources of the content provider (e.g., the same or similar to path data 162). In some implementations, the user exposure data may be based on business records and/or other data provided by the content provider to analysis system 150. From the user exposure data, analysis system 150 may determine whether the user is a potential new customer, or whether the user has had previous interactions with (e.g., previously purchased products/services from) the content provider. If analysis system 150 determines the user to be a potential new customer, analysis system 150 does not cause content management system 108 to limit serving of campaign items to the user (e.g., does not place the identifier on negative remarketing list 170) (310). In some implementations, analysis system 150 may (e.g., at the request of the content provider) exempt the identifier from placement on the list even if the user has had a limited number of previous interactions with the content provider (e.g., a predetermined number of previous purchases), for example, in an effort to encourage the user to become a regular customer. In some implementations, analysis system 150 may require that the user meet one or more requirements or characteristics, even if the user is identified as a potential new customer, before the identifier is exempted from negative remarketing list 170.

If the user is not a potential new customer, analysis system 150 may determine whether a profit margin for the product(s)/service(s) associated with the content item exceeds a threshold profit margin (320). The content provider may be willing to accept a greater loss on marketing for content items having higher profit margins. Analysis system 150 may determine whether the profit margin exceeds the threshold based on profit margin data generated by analysis system 150 and/or provided by the content provider. In some implementations, analysis system 150 may allow the content provider to determine the threshold value for exemption. In some implementations, analysis system 150 may additionally or alternatively determine whether to exempt an identifier from negative remarketing list 170 based on a category or type of product/service associated with the content item (e.g., vehicles, jewelry, high-end art, etc.). If the profit margin is higher than the threshold, analysis system 150 does not cause content management system 108 to limit serving of campaign items to the user (e.g., does not place the identifier on negative remarketing list 170) (310).

If the profit margin is not higher than the threshold, analysis system 150 may determine whether any other override settings in exemption data 180 (e.g., provided by the content provider) indicate that the identifier should not be added to negative remarketing list 170 (325). In some implementations, the content provider may provide a list of identifiers and/or characteristics for users/devices that should be exempted from negative remarketing list 170, for example, for business purposes. In one illustrative implementation, a content provider may wish to exempt identifiers associated with users who have shown an interest in a particular product or category of products (e.g., through keyword searches), because the content provider wishes to saturate the market for that product/category and/or block competitors. If any override settings indicate the identifier should not be added to negative remarketing list 170, analysis system 150 may exempt the identifier (310). If no such override settings apply, analysis system 150 may cause content management system 108 to limit serving of campaign items to the user (e.g., may place the identifier on negative remarketing list 170) (330).

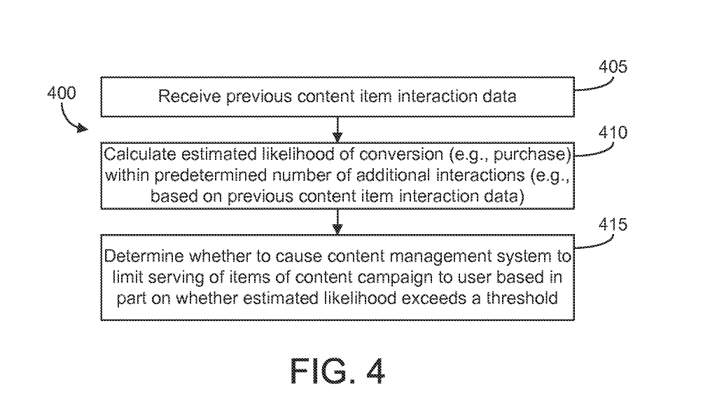

In some implementations, analysis system 150 may be configured not to cause content management system 108 to limit serving of campaign items to the user (e.g., not to add an identifier to negative remarketing list 170) if it is highly likely that one or more incremental impressions will result in conversion, even if the cumulative interactions with the user are already past the point of profitability. FIG. 4 is a flow diagram of a process for determining whether to cause content management system 108 to limit serving of campaign items to the user based in part on an estimated likelihood of conversion according to an illustrative implementation. A content provider may wish to continue presenting a limited number of impressions to a user past the profitability point when they are highly likely to result in near-term conversion, as investing a small amount of additional budget in a near-converting user may be less unprofitable than stopping any further spending and abandoning the user altogether. For example, consider a user on whom a cumulative cost of $50 has been spent marketing a product having a $45 profit margin. If analysis system 150 adds this user to negative remarketing list 170, the loss to the content provider will be $50. However, if three additional $5 clicks would result in a purchase from the user, the total cost to the content provider would be $65, and the resultant revenue would be $45, leading to a smaller loss of the overall interaction of $20. Therefore, in this case, it is in the content provider's best interest to continue providing impressions to the user if they are likely to drive a near-term conversion.

Referring now to both FIGS. 1 and 4, a conversion estimation module 182 of analysis system 150 may be configured to receive and/or collect previous content item interaction data (405). In some implementations, the previous interaction data may relate to previous interactions of the user being analyzed with content items from the content campaign being analyzed. In some implementations, the previous interaction data may relate to previous interactions of the user being analyzed with any content items (e.g., to increase the amount of data from which trends can be discerned). In some implementations, the previous interaction data may relate to previous interactions of one or more other users with content items of the campaign and/or other content items. In some implementations, the data used for the analysis may be data for users sharing one or more characteristics (e.g., browsing and/or shopping characteristics) in common with the analyzed user, and/or for content items sharing one or more characteristics in common with the content items/campaigns being analyzed (e.g., similar types of content items, similar marketed products/services, similar price points, etc.). Analysis system 150 may be configured to obtain a large amount of data, in some implementations, to increase the probability of an estimated likelihood of conversion being relatively accurate.

Analysis system 150 may be configured to calculate an estimated likelihood of conversion (e.g., purchase) within a predetermined number of additional interactions (e.g., additional presented impressions and/or click-throughs) (410). The estimated likelihood of conversion may be calculated based on the previous interaction data. Analysis system 150 may be configured to process the data to identify trends on which the estimated likelihood of conversion may be based. For example, if a particular user is found to purchase a product after clicking through content items relating to the product five times on average, and the user has clicked through three previous content items relating to the product already, analysis system 150 may estimate a high likelihood (e.g., 80%) of the user converting within the next three click-throughs. In some implementations, the estimated likelihood of conversion may be based on a confidence value associated with the estimated likelihood value. For example, if a small population of previous interaction data is used to generate the estimate and/or if the population is not substantially similar to the user and/or campaign being analyzed, the confidence value may be low. If a large population of previous interaction data for the user or for similar users/content items is used to generate the estimate, the confidence value may be high. In some implementations, the confidence value may be used to modify (e.g., lower) the estimated likelihood value and/or may be used as a factor by analysis system 150 when determining whether to cause content management system 108 to limit serving of campaign items to the user. In some implementations, analysis system 150 may calculate different estimated likelihood of conversion values for different types of interactions (e.g., impressions, click-throughs, etc.) and/or different numbers of interactions (e.g., three additional interactions, five additional interactions, etc.).

Analysis system 150 may determine whether to cause content management system 108 to limit serving of campaign items to the user (e.g., whether to place the identifier on negative remarketing list 170) based in part on the estimated likelihood of conversion (415). In some implementations, analysis system 150 may place the identifier on negative remarketing list 170 if the estimated likelihood of conversion does not exceed a threshold value, and may exempt the identifier from placement on negative remarketing list 170 if the estimated likelihood of conversion exceeds the threshold value. In some implementations, the threshold may be set by the content provider. In some implementations, the estimated likelihood of conversion may be used in combination with other exemptions to determine whether to place the identifier on negative remarketing list 170. In some implementations, analysis system 150 may be configured to allow a content provider to extend the analysis model to utilize different lookback windows (e.g., periods from which previous interaction data is collected for use in the analysis) and/or profitability levels, for example, based on a scope of the campaign.

In some implementations, various features of analysis system 150 may be implemented within a user device 104. For example, a user device may be configured to run a script or otherwise track a cumulative user cost associated with an interaction of the user device with one or more content campaigns. The user device may receive cost data relating to the interactions, and may accumulate the cumulative user cost. Once the cost exceeds a threshold, the user device may transmit an alert to content management system 108 that the cumulative user cost has exceeded a threshold point (e.g., a point of profitability). In some implementations, a portion of the functionality of analysis system 150 may be implemented within a user device and a portion of the functionality may be implemented within systems 108 and/or 150.

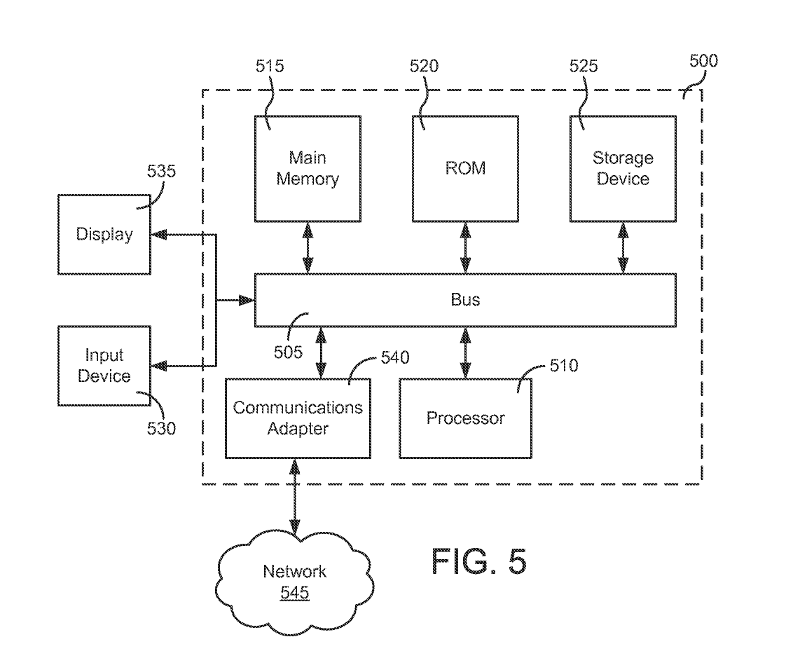

FIG. 5 illustrates a depiction of a computer system 500 that can be used, for example, to implement an illustrative user device 104, an illustrative content management system 108, an illustrative content provider device 106, an illustrative analysis system 150, and/or various other illustrative systems described in the present disclosure. The computing system 500 includes a bus 505 or other communication component for communicating information and a processor 510 coupled to the bus 505 for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 545 and/or other computing systems. In various illustrative implementations, any type of networking configuration may be achieved using communications adapter 540, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
receiving, by one or more processors, path data indicating one or more previous interactions of a user with one or more content items of a content campaign;
receiving, by the one or more processors, cost data used to determine a cost, to a content provider associated with the content campaign, of the one or more previous interactions;
calculating, by the one or more processors, a cumulative user cost associated with the user based on the cost data for the one or more previous interactions of the user reflected in the path data, the cumulative user cost representing a total cost incurred by the content provider in association with the one or more previous interactions of the user with the one or more content items of the content campaign;
determining an expected revenue contribution from the user resulting from a conversion;
comparing, by the one or more processors, the cumulative user cost to the expected revenue contribution from the user; and
determining, by the one or more processors, whether to cause a content management system serving content items to limit serving of content items of the content campaign to the user based on the comparison of the cumulative user cost to the expected revenue contribution.

2. The method of claim 1, wherein determining whether to cause the content management system to limit serving of content items of the content campaign to the user comprises determining whether to place an identifier associated with the user in a negative remarketing list, wherein the negative remarketing list is associated with at least one of the content provider and the content campaign, and wherein the negative remarketing list is configured to cause the content management system to limit serving content items of the content campaign to users when identifiers associated with the users appear in the negative remarketing list.

3. The method of claim 2, further comprising:
receiving a duration of time during which identifiers remain on the negative remarketing list from the content provider; and
removing identifiers from the negative remarketing list after the identifiers have been on the negative remarketing list for the duration of time.

4. The method of claim 1, further comprising determining whether to exempt the identifier associated with the user from the negative remarketing list based on override data received from the content provider.

5. The method of claim 1, wherein determining whether to cause the content management system to limit serving of content items of the content campaign to the user comprises causing the content management system to limit serving of content items of the content campaign to the user when the cumulative user cost exceeds the expected revenue contribution from the user.

6. The method of claim 1, wherein the path data comprises keywords associated with the one or more previous interactions, and wherein the cost data comprises costs associated with the keywords for the content provider.

7. The method of claim 1, wherein determining an expected revenue contribution from the user comprises determining an expected order value based on a plurality of orders previously placed by users after being presented with and selecting the content item.

8. The method of claim 1, wherein the determination of whether to cause the content management system to limit serving of content items of the content campaign to the user is further based on user exposure data indicating whether the user is a potential new customer of the content provider.

9. The method of claim 8, wherein determining whether to cause the content management system to limit serving of content items of the content campaign to the user comprises determining not to cause the content management system to limit serving of content items of the content campaign to the user when the user exposure data indicates that the user is a potential new customer of the content provider.

10. The method of claim 1, wherein the determination of whether to cause the content management system to limit serving of content items of the content campaign to the user is further based on profit margin data for a product or service associated with the content item.

11. The method of claim 10, wherein determining whether to cause the content management system to limit serving of content items of the content campaign to the user comprises determining not to cause the content management system to limit serving of content items of the content campaign to the user when the profit margin data indicates that a profit margin for the product or service associated with the content item exceeds a threshold profit margin.

12. The method of claim 1, further comprising calculating an estimated likelihood that a conversion will occur within a predetermined number of additional interactions of the user with the one or more content items of the content campaign, wherein the determination of whether to cause the content management system to limit serving of content items of the content campaign to the user is based in part on whether the estimated likelihood exceeds a threshold likelihood.

13. The method of claim 12, wherein calculating the estimated likelihood comprises analyzing data relating to at least one of:
one or more previous interactions of the user with content items, or
one or more previous interactions of other users with content items, wherein the other users share a plurality of user characteristics with the user.

14. The method of claim 1, wherein causing a content management system serving content items to limit serving of content items of the content campaign to the user comprises causing the content management system to do one of limiting a number of impressions of content items from the content campaign served to the user or stopping serving of content items from the content campaign to the user.

15. A system comprising:
at least one computing device operably coupled to at least one memory and configured to:
receive path data indicating one or more previous interactions of a user with one or more content items of a content campaign;
receive cost data used to determine a cost, to a content provider associated with the content campaign, of the one or more previous interactions;
calculate a cumulative user cost associated with the user based on the cost data for the one or more previous interactions of the user reflected in the path data, the cumulative user cost representing a total cost incurred by the content provider in association with the one or more previous interactions of the user with the one or more content items of the content campaign;
determine an expected revenue contribution from the user resulting from a conversion;
compare the cumulative user cost to the expected revenue contribution from the user; and
determine whether to cause a content management system serving content items to limit serving of content items of the content campaign to the user based on the comparison of the cumulative user cost to the expected revenue contribution.

16. The system of claim 15, wherein the at least one computing device is configured to determine whether to place an identifier associated with the user in a negative remarketing list, wherein the negative remarketing list is associated with at least one of the content provider and the content campaign, and wherein the negative remarketing list is configured to cause the content management system to limit serving content items of the content campaign to users when identifiers associated with the users appear in the negative remarketing list.

17. The system of claim 16, wherein the at least one computing device is further configured to:
receive a duration of time during which identifiers remain on the negative remarketing list from the content provider; and
remove identifiers from the negative remarketing list after the identifiers have been on the negative remarketing list for the duration of time.

18. The system of claim 16, wherein the at least one computing device is configured to determine whether to exempt the identifier associated with the user from the negative remarketing list based on override data received from the content provider.

19. The system of claim 15, wherein the at least one computing device is configured to cause the content management system to limit serving of content items of the content campaign to the user when the cumulative user cost exceeds the expected revenue contribution from the user.

20. The system of claim 15, wherein the at least one computing device is configured to determine the expected revenue contribution from the user by determining an expected order value based on a plurality of orders previously placed by users after being presented with and selecting the content item.

21. The system of claim 15, wherein the at least one computing device is configured to determine whether to cause the content management system to limit serving of content items of the content campaign to the user further based on user exposure data indicating whether the user is a potential new customer of the content provider, and wherein the at least one computing device is configured to not cause the content management system to limit serving of content items of the content campaign to the user when the user exposure data indicates that the user is a potential new customer of the content provider.

22. The system of claim 15, wherein the at least one computing device is configured to determine whether to cause the content management system to limit serving of content items of the content campaign to the user further based on profit margin data for a product or service associated with the content item, and wherein the at least one computing device is configured to not cause the content management system to limit serving of content items of the content campaign to the user when the profit margin data indicates that a profit margin for the product or service associated with the content item exceeds a threshold profit margin.

23. The system of claim 15, wherein the at least one computing device is configured to calculate an estimated likelihood that a conversion will occur within a predetermined number of additional interactions of the user with the one or more content items of the content campaign, wherein the at least one computing device is configured to determine whether to cause the content management system to limit serving of content items of the content campaign to the user based in part on whether the estimated likelihood exceeds a threshold likelihood.

24. One or more non-transitory computer-readable storage media having instructions stored thereon that, when executed by at least one processor, cause the at least one processor to perform operations comprising:
receiving path data indicating one or more previous interactions of a user with one or more content items of a content campaign;
receiving cost data used to determine a cost, to a content provider associated with the content campaign, of the one or more previous interactions;
calculating a cumulative user cost associated with the user based on the cost data for the one or more previous interactions of the user reflected in the path data, the cumulative user cost representing a total cost incurred by the content provider in association with the one or more previous interactions of the user with the one or more content items of the content campaign;
determining an expected revenue contribution from the user if a content item of the content campaign is displayed to the user and the user selects the content item and subsequently purchases a product or service associated with the content item;
comparing the cumulative user cost to the expected revenue contribution from the user; and
placing an identifier associated with the user in a negative remarketing list when the cumulative user cost exceeds the expected revenue contribution from the user, wherein the negative remarketing list is associated with at least one of the content provider and the content campaign, and wherein the negative remarketing list is configured to cause a content management system serving content items to users to not serve content items of the content campaign to users when identifiers associated with the users appear in the negative remarketing list.

25. The one or more non-transitory computer-readable storage media of claim 24, wherein the operations further comprise exempting the identifier associated with the user from being placed on the negative remarketing list when at least one of the following is true:
user exposure data indicates that the user is a potential new customer of the content provider;
profit margin data indicates that a profit margin for the product or service associated with the content item exceeds a threshold profit margin; or
override data received from the content provider indicates that the identifier associated with the user should be exempted from the negative remarketing list.

26. The one or more non-transitory computer-readable storage media of claim 24, wherein the operations further comprise:
calculating an estimated likelihood that the user will purchase the product or service associated with the content item within a predetermined number of additional interactions of the user with the one or more content items of the content campaign; and
determining whether to exempt the identifier associated with the user from being placed on the negative remarketing list based on whether the estimated likelihood exceeds a threshold likelihood.
